(19) United States
(12) Patent Application Publication
(10) Pub. No.: US 2020/0384997 A1
(43) Pub. Date: Dec. 10, 2020

(54) Convoy of Variable Gap

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/433,140

(22) Filed: Jun. 6, 2019

(51) Int. Cl. B60W 30/165; G08G 1/00; G05D 1/02; B60W 30/16

(52) U.S. Cl. CPC B60W 30/165; G08G 1/22; G05D 1/0295; B60W 2530/10; B60W 2550/14; B60W 2550/308; B60W 30/162

(57) ABSTRACT

Different separation distances are required and needed for different applications. For example, in some areas of the road, it may be advantageous to have trucks platoon at short distances due to the drafting effect and the associated fuel savings, however, in other areas, it is beneficial to have vehicles at longer separations. For example, if we have long strings of trucks in a single convoy, they may block the rest of the traffic from exiting or turning. There is a need to allow an operator or even automatically to have the system adjust the following distances. At short distances, short range communication, and fast control loops are necessary, at longer distances, control effects are less pronounced and the sensors that are efficient at short distances become inefficient at long distances and vice-versa. The system in presented here provides a mechanism for manually or automatically modifying the following gaps. The system not only allows for different gaps, but it also allows for the gaps to be automatically be determined given a variety of conditions.

### CROSS-REFERENCES TO RELATED APPLICATIONS

Not applicable.

### BACKGROUND OF THE INVENTION

### 1. Field of the Invention

The present invention involves the need to allow the operator or even automatically have the system adjust the following distance for the various separation distances required for different applications. At short distances, short range communications and fast control loops are needed, while at longer distances, control effects are less pronounced and the sensors that are efficient at short distances become inefficient at long distance and vice-versa. The system in the present invention allows for a mechanism for manually or automatically modifying the following gaps. In addition, the system not only allows for different gaps, but also allows for the gaps to be automatically determined given a variety of conditions.

### 2. Description of Related Art

The statements in this section merely provide background information related to the present disclosure and may not constitute prior art.

There have been no reports in the patent literature which allows the operator or automatic system adjustment of the following distance for various separation distances required for many different applications.

There has been a patent, U.S. Pat. No. 9,475,422 that involves the communication of autonomous vehicles with external observers. The method involves receiving a task at the autonomous vehicle; collecting data that characterizes a surrounding environment of the autonomous vehicle from a sensor coupled with the autonomous vehicle, determining the intended course of action based on the task and collected data and then conveying a human understandable output indicating the course of action to an external observer.

Another patent, U.S. Pat. No. 7,979,172 relates to creating dedicated travel lanes for autonomous vehicles, determination of location of the autonomous vehicles in the dedicated travel lanes, providing instructions to the autonomous vehicles in the dedicated travel lanes to enable them to travel in a manner that maximizes speed. To determine the location of the vehicles, a vehicle travel management system can be arranged in each of the autonomous vehicles to determine the location of that autonomous vehicle, e.g., using a GPS-based positioning system or similar system, and which also optionally receives travel instructions which can be implemented by a vehicle control system to control the direction and speed of the vehicle and can be designed to assume control of vehicle travel without requiring driving by an occupant of the vehicle and control vehicle travel based on the operator-provided instructions.

A navigation and control system including position sensors configured to generate position signals indicative of the location and heading of a vehicle has been developed as can be seen in Canadian Patent No. #2,739,989. In another patent, the autonomous vehicle is configured to operate in autonomous mode, and it is possible to determine the current state of the vehicle and vehicle environment. The autonomous vehicle environment comprises at least one other autonomous vehicle being present. At least one prediction operation of the other vehicle may be determined based on the current state and the current state of the environment of the vehicle.

There has been a patent, U.S. Pat. No. 9,612,123, related to autonomous vehicles and associated mechanical, electrical and electronic hardware, computer software and systems, and wired and wireless network communications to provide map data for autonomous vehicles. A method has been developed that includes accessing subsets of multiple types of sensor data, aligning subsets of sensor data relative to a global coordinate system based on the multiple types of sensor data to form aligned sensor data, and generating datasets of three-dimensional map data. The method also includes detecting a change in data relative to at least two datasets of the three-dimensional map data and applying the change in data to form updated three-dimensional map data. The change in data may be representative of a state change of an environment at which the sensor data is sensed.

There have been no reports in the patent literature on methods or systems for manually or automatically modifying the gaps between autonomous vehicles for different applications.

### SUMMARY OF THE INVENTION

There is a great need to develop accurate distance measurements in cases where two autonomous vehicles follow near each other as well as develop methods to use in the case where the autonomous vehicles are far away from each other. The two different types of gaps of the autonomous convoys require vastly different types of actions of the autonomous vehicles.

A system has been developed to manually or automatically adjust the following distances between autonomous vehicles. This system not only allows for different gaps, but also allows for the gaps to be automatically determined given a variety of conditions.

A method has been developed to further reduce the response time of the sensors and actuators along with the use of the DSRC. Feed forward commands from the lead vehicle will be sent though the ranging radios to complement the feedback created by the errors in separation provided by the ranging radios. In other words, the acceleration and steering of the first vehicle, need to be coded as part of the leader's path and sent to the followers to minimize the effects of actuation delays.

Modelling of the braking and acceleration profiles of the vehicles of the convoy. The resulting models are used to predict acceleration and deceleration distances and automatically determine the minimum following safe distance given the load characteristics, weather, and communications characteristics.

A method has been developed for establishing communications at larger separations such as 1000 m to 6-month. This method involves having the leader on the route clearance convoy, and the follower on the logistic convoy's hours after the fact.

For short distances, the communication and reaction times will be minimized, braking distances modelled, and TOP enhanced to include feedforward (acceleration, steering and brake) to be shared by the leader and followers, and automatic determination of minimum following distances given the determined load and characteristics of the vehicles in the convoy. Feedback will be given to the driver if he/she exceeds the capabilities of the followers.

### BRIEF DESCRIPTION OF THE DRAWINGS

FIG. 1 shows a schematic of the system used to measuring distances for autonomous vehicles (100, 102) that are near each other which are comprised of ranging radios (103) used for autonomous vehicles (100, 102) travelling along a road network (101).

FIG. 2 shows autonomous vehicles (200, 204) that are very close to each other in which there is active communications (203) between the autonomous vehicles (200, 204) by the use of ranging radios (201). The lead autonomous vehicle (200) has a database which comprises terrain profile/load and the following autonomous vehicle (204) contains a database which comprises the acceleration profile (206).

FIG. 3 shows autonomous vehicles (300, 302) that have very large separation distances (301) from each other where there are no active communications between the autonomous vehicles that are travelling in the road network (303).

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

The present invention describes a system for convoying vehicles with variable gaps that comprise two or more autonomous vehicles, a database containing the acceleration and deceleration profiles of each vehicle in the convoy, an operator control unit that allows the controllers to set and vary a separation distance, measurement of the distance between the autonomous vehicles in the convoy either directly or by using external devices such as a GPS, a control system in each autonomous vehicle that uses the current separation system between the autonomous vehicles and optimizes the separation distance for each autonomous vehicle in the convoy and a drive by wire system capable of accelerating and braking using the commands created by the control system.

Acceleration profiles show the changes in the velocities that occur in which the velocities increase while deceleration profiles show the changes in the velocities that occur in which the velocities decrease.

GPS stands for Global Positioning System and is a satellite-based navigation system made up of at least 24 satellites. They were originally only for military use but became available for civilian use in the 1980s.

A drive-by-wire system is the use of electrical or electro-mechanical systems for performing vehicle functions traditionally performed by mechanical linkages.

In this system, the drive by wire system provides steering according to the results of the control system algorithms. The control system uses a feedforward model of each autonomous vehicle. In addition, the control system uses the deceleration rates, the acceleration rates, the elevation profile of the road ahead, the slope of the road ahead, the surface type of the road ahead or the mass of each vehicle as part of the computation used by the algorithms.

The feedforward model requires integration of the mathematical model into the control algorithm such that it is used to determine the control actions based on what is known about the state of the system being controlled.

Elevation profiles of the road ahead includes a depiction of a two-dimensional cross-sectional view of a landscape. It provides a side view of a terrain's elevation along a line drawn between locations on a map. The slope of the road ahead refers to the tangent of the angle of that surface to the horizontal. It is a special case of the slope, where zero indicates horizontality. A larger number indicates higher or steeper degree of “tilt”. Often slope is calculated as a ratio of “rise” to “run”, or as a fraction (“rise over run”) in which the run is the horizontal distance (not the distance along the slope) and rise is the vertical distance.

In this system, the distance optimizer, which is part of the control system, uses information of the autonomous vehicle in the front, or the two autonomous vehicles in front, or multiple autonomous vehicles in the front. Also, the distance optimizer uses information of all autonomous vehicles in the convoy.

The distance optimizer that is part of the control system shows you the quickest route, shortest route, and optimized driving directions in the path you are travelling.

In this system, there is a centralized control system that computes and controls the separation distance for the convoy. In addition, the control system is decentralized and located on each autonomous vehicle.

The minimum separation distances are computed based on the safety parameters computed from the road elevation profile, the road condition, and the weather conditions.

The autonomous vehicles use fiducials to measure the distances. They use external features such as vegetation, road markings, etc.) to find the distance between them by recognizing the same features already marked by previous autonomous vehicles.

Fiducials are an object placed in the field of view of an imaging system which appears in the image produced, for use as a point of reference or a measure. It may be either something placed into or on the imaging subject, or a mark or set of marks in the reticle of an optical instrument.

The following distances are provided by the operator as a range, and the optimal distances are computed by the control system within the range provided by the operator. The drive by wire commands provided by the autonomous vehicles ahead are transmitted to the followers.

The obstacles, road elevation profile, and road condition based on the weather are measured by the first autonomous vehicle and sent to subsequent autonomous vehicles. As the distances between the autonomous vehicles increases, different sensors are automatically used to measure gap distances. At short distances which are defined as the distances within which there is active communications, ranging radios and fiducials are used to measure gap distances. At mid-range distances, which are above the threshold where there are no active communications up to 1000 m, ranging radios and GPS are used to measure gap distance. At long range distances, which are greater than 1000 m and also where there are no active communications present, GPS and environmental features are used to measure gap distances.

The control system can recommend a particular ordering of the vehicles in the convoy to optimize speed, fuel consumption, or other utility function. Also, the a-priori knowledge of the road elevation profile, road turns, maximum and minimum speed, and road conditions are used as part of the control system. The autonomous vehicles in the convoy continually monitor their acceleration profiles and deceleration profiles to measure for brake wear or brake temperature and communicate the changes in these profiles to the rest of the autonomous vehicles in the convoy.

The gaps are controlled differently when the convoy travels next to highway exits to allow other autonomous vehicles not in the convoy to exit. Walls are not created to block the rest of the traffic from exiting the highway. The gaps are also controlled differently when the convoy travels in roundabouts to allow the autonomous vehicles not in the convoy to exit similarly like in the case of the highways. The changes in the gap occur if other traffic is present and is maintained tight if no other traffic is present. In addition, the autonomous vehicles in the convoy monitor for traffic and for turning (merging) signals to separate the gaps. The control system on the autonomous vehicles detects merging signals on other traffic to increase separation gaps and allow the rest of the traffic to merge within the convoy.

An assumption is made that the lead vehicle is equipped with sensors capable of measuring some road features. In particular, road elevation profile, terrain type, weather conditions, and dynamic response of the vehicle (max acceleration, max braking, tractive effort, mass, etc.) are important aspects of the invention. Alternatively, the leader control system can provide this information from external sources.

An assumption is made that one or more of these road features are measured. Moreover, there is a set of lead driver behaviors that can be recorded including steering, acceleration, brake, signaling, etc. In addition, it is assumed that the follower can also measure (or be informed) of some of its own dynamic behavior, including its acceleration, deceleration profiles, drive by wire delays, communication delays, maximum steering rates, mass, etc.

In the case where the trucks are following each other at absurdly small distances (1 cm), as the leader accelerates from a stop, a follower that reacts to the separation error most likely will not be able to track the 1-centimeter distance without having significant following errors because of several factors. Some factors are impossible to overcome due to the physics involved in the problem (observability and controllability of the system). For example, if the follower is heavily loaded, it may not be able to create sufficient acceleration to follow accurately, the road incline will also have a similar effect on the braking side. The road conditions may not allow the follower to create enough traction without slipping. Also, from a control standpoint, a system that solely uses the gap distance even if accurately measured is susceptible to communication delays, processing delays, and drive-by-wire delays that can ultimately also add errors to the system.

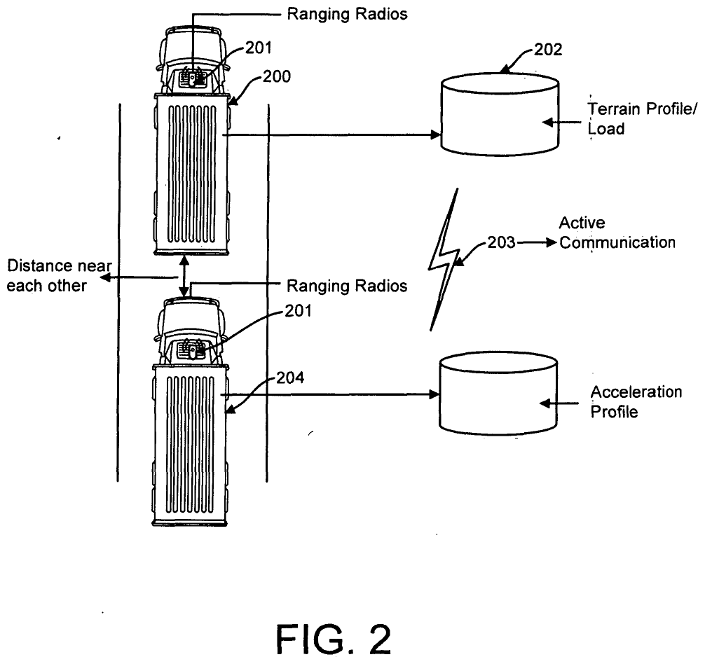

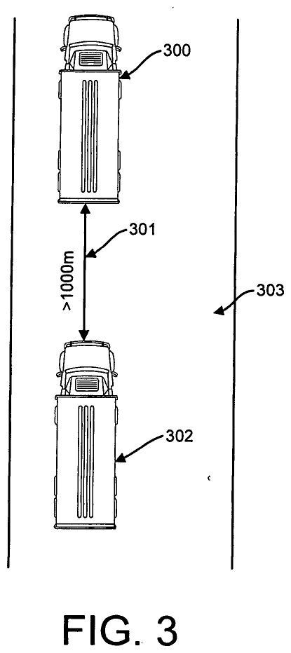

Autonomous Vehicles Near Each Other: Autonomous vehicles being near each other is defined as having a distance in which there is still active communications between the autonomous vehicles. FIG. 2 illustrates an example of a case where the two autonomous vehicles (200, 204) are near each other. In this case, ranging radios (201) are used to communicate information via active communication signals (203) to the following autonomous vehicles (204). The lead autonomous vehicle (200) has the terrain profile/load (202) information in the online database while the following autonomous vehicle (204) has the acceleration profile (206) information in the online database. When there are no more active communications between the autonomous vehicles as illustrated in the example shown in FIG. 3, then the autonomous vehicles are no longer considered to be near each other. In this example, the autonomous vehicles (300. 302) are greater than 1000 meters away (301) from each other.

Autonomous Vehicles Far Away From Each Other: In these cases, the separations between the autonomous vehicles is larger than 1000 meters and these distances are also those in which communications between the autonomous vehicles are lost and that there is not active communications between the autonomous vehicles that are established with the ranging radios in which the situation illustrated in FIG. 3 applies. Here, the autonomous vehicles (300, 302) are travelling on a road network (303) in which there is a large distance greater than 1000 meters (301) separating the autonomous vehicles from each other. When the autonomous vehicles come closer to each other with separations less than 1000 meters, then the autonomous vehicles are in active communications with each other via the use of the ranging radios and the situation illustrated in FIG. 2 applies. Here, the autonomous vehicles are close to each other (200, 204) and are travelling along a road network (205). Ranging radios (201) are used to provide active communications (203) between the lead autonomous vehicle (200) and the following autonomous vehicle (204) in the convoy. The lead autonomous vehicle contains the terrain profile/load information (202) in its online database while the following autonomous vehicle contains the acceleration profile (206) information in its online database.

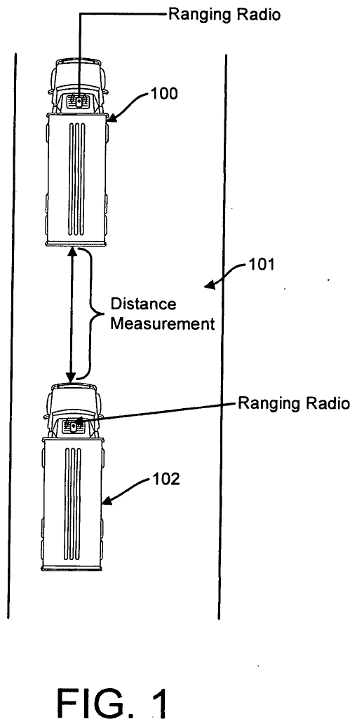

In the case where the autonomous vehicles are near each other and there are active communications between the autonomous vehicles by the use of ranging radios as illustrated in FIG. 1 as (201), the communications and response time of the ranging radio sensors and actuators are lowered. The direct measurement of the distances between the autonomous vehicles with the use of ranging radios is extremely important when the autonomous vehicles are close to each other.

The acceleration and steering of the lead autonomous vehicle is coded as part of its path and sent to the rest of the autonomous convoy to minimize actuation delays when the autonomous vehicles are near each other.

In the case of when the autonomous vehicles are far away from each other and active communications are lost between the autonomous vehicles, feed forward commands are sent from the lead autonomous vehicle through the ranging radios to complement the feedback created by the errors in separation provided by the ranging radios.

In the case where there are very large separation distances between the autonomous vehicles and active communications between the autonomous vehicles are lost, the lead autonomous vehicle is on the route clearance convoy and the following autonomous vehicles is on the logistic convoy's hours after the fact.

In addition, modelling has been performed to predict the acceleration and deceleration distances and the minimum safe following distances have been determined that are based on the load characteristics, weather, and communication characteristics.

Also, modelling has been performed in which the TOP is enhanced to include feedforward (acceleration, steering, and brake) to be shared by the lead autonomous vehicle and following autonomous vehicles. In addition, there is automatic determination of the minimum following distances based on the load and characteristics of the autonomous vehicles in the convoy.

Feedback is given to the lead autonomous vehicle if it exceeds the capabilities of the following autonomous vehicles.

The embodiments of the invention in which an exclusive property or privilege is claimed are defined as follows:

1. A system for convoying vehicles with variable gaps comprising:
two or more autonomous vehicles;
a database consisting of the acceleration and deceleration profiles of each vehicle in the convoy;
an operator control unit that allows the controllers to set and vary a separation distance;
measurement of the distance between the autonomous vehicles in the convoy (either direct measure, or using external devices like GPS);
a control system in each vehicle that uses the current separation system between the autonomous vehicles and optimizes the separation distance for each autonomous vehicle in the convoy and;
a drive by wire system capable of accelerating and braking using the commands created by the control system.

2. The system of claim 1 wherein the drive by wire system also provides steering according to the results of the control system algorithms.

3. The system of claim 1 wherein the control system utilizes a feedforward model of each autonomous vehicle.

4. The system of claim 1 wherein the control system may use the deceleration rates, the acceleration rates, the elevation profile of the road ahead, the slope of the road ahead, the surface type of the road ahead, or the mass of each vehicle as part of the computation.

5. The system of claim 1 wherein the distance optimizer as part of the control system uses information of the autonomous vehicle in front, or the two autonomous vehicles in front, or multiple autonomous vehicles in front.

6. The system of claim 1 wherein the distance optimizer utilizes information of all autonomous vehicles in the convoy.

7. The system of claim 1 where there is a centralized control system that computes and controls the separation distance for the convoy.

8. The system of claim 1 wherein the control system is decentralized and located on each autonomous vehicle

9. The system of claim 1 wherein the minimum separation distances are computed given the safety parameters computed from the road elevation profile, the road condition, and the weather conditions.

10. The system of claim 1 wherein the autonomous vehicles use fiducials to measure the distances.

11. The system of claim 1 wherein the autonomous vehicles use external features (vegetation, road markings, etc.) to find the distance between them by recognizing the same features already marked by previous autonomous vehicles.

12. The system of claim 1 wherein the following distances are provided by the operator as a range, and the optimal distances are computed by the control system within the range provided by the operator.

13. The system of claim 1 wherein the drive by wire commands provided by the autonomous vehicles ahead are transmitted to the followers.

14. The system of claim 1 wherein the obstacles, road elevation profile, and road condition based on the weather are measured by the first autonomous vehicle and sent to subsequent autonomous vehicles.

15. The system of claim 1 wherein as distances increase, different sensors are automatically used to measure gap distances.

16. The system of claim 1 wherein at short distances, ranging radios and fiducials are used to measure gap distance, at mid-ranges, ranging radios and GPS are used to measure gap distance, and at long ranges, GPS and environmental features are used to measure gap distances.

17. The system of claim 1 wherein the control system can recommend a particular ordering of the vehicles in the convoy to optimize speed, fuel consumption, or other utility functions.

18. The system of claim 1 where a-priori knowledge of the road elevation profile, road turns, maximum and minimum speed, and road conditions are used as part of the control system.

19. The system of claim 1 wherein the autonomous vehicles in the convoy continually monitor their acceleration profiles and deceleration profiles to measure for brake wear (or brake temperature) and communicate the changes in these profiles to the rest of the autonomous vehicles in the convoy.

20. The system of claim 1 wherein the gaps are controlled differently when the convoy travels next to highway exits to allow other autonomous vehicles not in the convoy to exit.

21. The system of claim 1 wherein walls are not created to block the rest of the traffic from exiting the highway.

22. The system of claim 1 wherein the gaps are controlled differently when the convoy travels in roundabouts to allow other autonomous vehicles not in the convoy to exit.

23. The system of claims 22 and 24 wherein the changes in gap occur if other traffic is present and is maintained tight if no other traffic is present.

24. The system of claims 22 and 24 wherein the autonomous vehicles in the convoy monitor for traffic and for turning (merging) signals to separate the gaps.

25. The system of claim 1 where the control system on the autonomous vehicles detects merging signals on other traffic to increase separation gaps and allow the rest of the traffic to merge within the convoy.
